(19) United States
(12) Patent Application Publication
(10) Pub. No.: US 2002/0089535 A1
(43) Pub. Date: Jul. 11, 2002

(54) Methods for providing layered continuity icons and portable return links so produced

(76) Inventor: Calvin Morrell JR., Irvine, CA (US)

Correspondence Address: Attn: Charles Brown, OPPENHEIMER WOLFF & DONNELLY LLP, Suite 3800, 2029 Century Park East, Los Angeles, CA, 90067, US

(21) Appl. No.: 10/043,672

(22) Filed: Jan. 9, 2002

Related U.S. Application Data
(60) Provisional application No. 60/260,439, filed on Jan. 9, 2001.

(51) Int. Cl. G09G 5/00

(52) U.S. Cl. 345/738

(57) ABSTRACT

The invention provides unique methods for generating repeat business through returning internet or network customers by providing mobile return links that travel with the customers. The return link travels by any object capable of being passed between Web sites, such as an applet. The object, including the return link, is generated when a customer leaves a first, base Web site. The object subsequently manifests the return link to the customer at other Web sites through sensory recognizable icons, providing the customer with a direct return link to the first Web site or to related Web sites.

### RELATED APPLICATIONS

This Application claims priority of U.S. Provisional Application No. 60/260,439 filed Jan. 9, 2001, incorporated herein by reference.

### BACKGROUND OF THE INVENTION

1. Field of the Invention:

The present invention relates to “surfing” the World Wide Web and providing continuity between a plurality of Web sites thereon. More particularly, the present invention relates to tracing a user's steps through various Web sites and providing a means for instantaneous return to a previously visited or to a related Web site, without requiring the user to re-trace his original steps.

2. General Background and State of the Art:

As the World Wide Web has grown in size and popularity, this virtual world has become a large arena of exploration for those who visit. Those who have established a presence on the Web, such as business entrepreneurs with commercial Web sites, have seen their presence diminish, proportionately, as more and more content has become available and greater numbers of people have established their own presences on the Web.

As with traditional brick and mortar businesses, those on the Web must seek ways to distinguish themselves and make themselves appealing to visitors and potential customers. Also, as in more traditional business arenas, Web businesses must keep an eye toward repeat business and actively seek return customers.

Because the World Wide Web has grown so quickly, it has been difficult for Web-based businesses to reliably and consistently entice or retain customers to ensure continuing business for a prosperous future. For example, traditional businesses can establish themselves such that they are geographically isolated from similar businesses to ensure a certain market share; this is not feasible for a Web-based business. Customers on the Web are not bound by geographic constraints, and are free to visit any Web-based business at any time.

While the World Wide Web has proven to be a lucrative marketplace, many traditional means of retaining customers, or soliciting their return once they have exited the store, are not applicable online. Because Web-based businesses are not able to establish a geographically unique presence, these businesses must discover, utilize and evolve alternative means for ensuring a customer's return after a customer has exited the online store or Web site. Presently, such means are limited.

One method that has been used by Web-based businesses involves the implication of multiple browser processes. When a customer leaves a first Web site, which was displayed to the user in a first browser window, to enter a second Web site, the first Web site will cause a second browser window to appear on the customer's computer screen. The first Web site thereby retains an open browser window, though minimized on the customer's computer screen, displaying its content. The customer is therefore less likely to forget about the first Web site and can easily return to it simply by activating the minimized first browser window. If the customer closes the second browser window, the content of the first Web site is still present and accessible to the customer in the first browser window, which was never closed.

Unfortunately, the use of multiple browser windows is awkward and cumbersome for customers. Furthermore, running multiple instances of a browser simultaneously is apt to slow customers' network connections. Either of these inconveniences is likely to cause a customer to go offline, rather than to continue engaging in business online. Alternatively, the customer may choose to simply close the minimized first browser window, in an effort to “clean up” his computer screen and eliminate idle processes. This, also, causes a cessation in that customer's engagement in business with the first Web site. In contrast, the present invention seeks to provide customers with simple, non intrusive and non cumbersome approaches for return-visits to previously visited Web sites and to related Web sites.

### SUMMARY OF THE INVENTION

The present invention provides Web-based businesses with methods and portable return links soliciting return customers, directing customers to related sites, and generating repeat business. The present invention further provides online customers with direct sensory continuity between Web sites, such that the customer can return to a previously-visited or base Web site or to a related Web site related to the base site via a simple, non-intrusive, one-step process. To accomplish these objectives, the present invention sends a portable sensory recognizable icon with a customer when the customer leaves a base or first Web site. As the customer visits subsequent Web sites, the sensory recognizable icon is made available to the customer, who can utilize it to instantly return to the first Web site or be directed to a related Web site. This instant return or link is made available via a one-step process, such as by clicking on the icon which may include a dynamic link to the first Web site. Moreover, the methods and associated sensory recognizable icons of the present invention are non-intrusive with respect to the content of subsequent Web sites visited by the customer so that the customer's access to such content is not limited or hampered by the present invention.

### BRIEF DESCRIPTION OF THE DRAWING

FIG. 1 illustrates an exemplary embodiment of the present invention where a first base Web site and a subsequent Web site, are in direct linked continuity via a sensory recognizable, layered, continuity icon.

### DETAILED DESCRIPTION OF THE INVENTION

In the following description of the present invention reference is made to the accompanying drawing which forms a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

In an exemplary embodiment of the present invention, a customer is provided with direct sensory recognizable continuity between multiple Web sites. sensory recognizable continuity is provided by layering a link generated from a base Web site upon a subsequent Web site visited by the customer. This link is contained within a transferable object, such as an applet, in accordance with the teachings of the present invention.

An applet is a program designed to be executed from within another application. Web browsers are typically equipped with Java virtual machines such that they can interpret Java applets from Web servers. Further, applets cannot be used to access users' hard drives, and are thus considered secure objects. Because applets are small files, cross-platform compatible, and highly secure, they are ideal for small Web-based applications accessible from a browser.

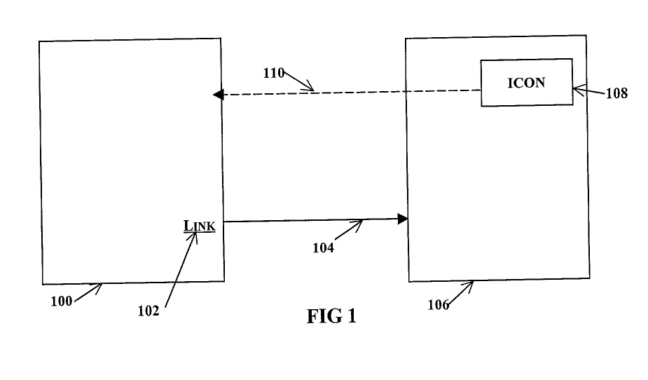

In the exemplary method of the present invention illustrated in FIG. 1 , a customer at a first or base Web site triggers an applet in accordance with the teachings of the present invention upon activating a link to a second Web site. This link directs the customer to the second Web site, and the applet travels with the customer to that second Web site. The applet can accomplish any of a number of functions within the scope and teachings of the present invention. In all cases, however, the applet manifests to the customer a direct sensory recognizable continuity link between the base Web site and the second, or subsequent Web site. This sensory recognizable continuity may be, for example, a visual icon such as a company logo or color scheme, or an auditory, olfactory, or tactile icon that contains a hyperlink directed to the first Web site itself or to a related Web site. The sensory recognizable icon is layered upon the second Web site, such that it appears above the content of the second Web site. When the customer activates the hyperlink, such as by clicking on a visual or other sensory recognizable icon, he is directed back to the first Web site or to a related Web site in a single step.

Such an exemplary method of the present invention is illustrated in FIG. 1 where a customer visits first, base Web site 100 and activates a link 102 thereat which directs 104 the customer via the Internet to second or subsequent Web site 106. In addition to directing the customer to subsequent Web site 106, activating link 102 spawns an applet that travels with the customer to subsequent Web site 106. The applet contains a hyperlink to base Web site 100, and manifests this hyperlink to the customer on subsequent Web site 106 as a visual icon 108. It will be appreciated by those skilled in the art that alternative sensory recognizable icons other than visual icons may be used within the scope of the present invention. The customer need only click on visual icon 108 to be automatically directed 110 via the Internet back to base Web site 100. It should be noted that activating the hyperlink of the present invention may also direct the customer to a Web site related to base Web site 100. Unlike the cumbersome and burdensome prior art methods, these unique methods of the present invention allowing easy customer return or direction to related Web sites require no additional browser windows, and allow the customer to simultaneously access both the content of subsequent Web site 106 as well as the return link made sensory recognizable by visual icon 108.

The direct sensory continuity so provided by the present invention may take any of a number of forms and, through the applet, may behave in any of a wide variety of fashions. For example, a visual or other sensory recognizable icon may be designed within the teachings of the present invention to directly represent content at the first Web site visited by a customer. Alternatively, the sensory recognizable icon may be designed in real-time, as the customer is browsing at the first Web site, to represent content at the first Web site which is known, by tracking the customer's behavior, to be of specific interest to that customer. In this way, the sensory recognizable icons of the present invention can be custom designed to be pleasing, attractive, and appealing to individual customers.

Further, the exemplary sensory recognizable icon is not limited to being stationary on a page of the second Web site. For example, with a visually recognizable icon it is contemplated as being within the scope of the present invention that the layered visual icon can move about the second Web site, and float above the content located there without restricting or limiting the customer's access to that content. The exemplary visual icon of the present invention, having any desired appearance, is non-intrusive, yet attention-grabbing. For example, the icon can be designed to have a whimsical, comical appearance. Such an exemplary visually recognizable icon could have the form of a blimp that flies over the content of the second Web site. If desired, the customer can disable such a visually recognizable icon through attention-grabbing visual techniques, such as by “bursting” and deflating the blimp. Similarly, the blimp may re-inflate itself after a period of time or after the customer instructs it to do so within the teachings of the present invention. Such features, and others, may be readily programmed in the applet of the present invention by those skilled in the art.

The foregoing description of exemplary embodiments of the present invention have been presented for purposes of enablement, illustration, and description. They are not intended to be exhaustive of or to limit the present invention to the precise forms discussed. Many modifications and variations of the present invention are possible in light of the above teachings. For example, the direct sensory recognizable continuity may be provided via audio, tactile, or olfactory recognition rather than by visual recognition alone. Also, the present invention is not limited to use between only two Web sites, as presented in the exemplary embodiments. Rather, the invention may be utilized with an unlimited number of Web sites or other nodes on a computer network.

It is intended that the scope of the present invention be limited not by this detailed description, but rather by the claims appended hereto.

I claim:

1. A method for providing direct sensory continuity between multiple network sites, the method comprising the steps of:
layering a link generated from a base site upon a subsequently accessed site to provide access from said subsequently accessed site to a site directly associated with said base site;
producing a sensory recognizable icon identifying said link; and
causing said link and said sensory recognizable icon to be available to a user when the user accesses the subsequently accessed site after accessing the base site.

2. The method of claim 1 wherein the site directly associated with the base site is the base site.

3. The method of claim 1 wherein the link is contained within a transferable object.

4. The method of claim 3 wherein the transferable object is an applet.

5. The method of claim 1 wherein the causing said sensory recognizable icon to be available to a user comprises causing the sensory recognizable icon to move within a window displaying the subsequently accessed site and above the content of the subsequently accessed site.

6. A method for producing a passive continuity icon for use in electronic networks having sites comprising:
receiving, at a first site, a signal from a user in response to the user activating a first link on the first site, the first link being associated with a second site and the activating causing the user to be directed to the second site;
generating an applet comprising a return link associated with said first site and a sensory recognizable icon; and
transferring the applet to the second site and causing the applet to be operational within the second site.

7. The method of claim 6 further comprising:
receiving, within the applet, a second signal from a user activating the return link within the applet at the second site; and
in response to receiving the second signal, causing the user to be re-directed to said first site.

8. The method of claim 6 further comprising:
receiving, at the second site, a signal from a user in response to the user activating a second link on the second site, the second link being associated with a third site and the activating causing the user to be directed to the third site;
generating an applet comprising a return link associated with said first site and a sensory recognizable icon; and
transferring the applet to the third site and causing the applet to be operational within the third site.

9. The method of claim 8 further comprising:
receiving, within the applet, a second signal from a user activating the return link within the applet at the third site; and
in response to receiving the second signal, causing the user to be re-directed to said first site.

10. The method of claim 6 wherein the applet, when operational within the second site, causes the sensory recognizable icon to be visible to the user above content appearing on the second site.

11. The method of claim 10 wherein the applet, when operational within the second site, further causes the sensory recognizable icon to move within a window displaying the content appearing on the second site.

12. The method of claim 8 wherein the applet, when operational within the third site, causes the sensory recognizable icon to be visible to the user above content appearing on the third site.

13. The method of claim 12 wherein the applet, when operational within the third site, further causes the sensory recognizable icon to move within a window displaying the content appearing on the third site.

14. A passive continuity icon for use in electronic networks having sites comprising:
a dynamic link generated from a base site and layered upon a subsequent site;
the dynamic link provides a user with direct access from said subsequent site to a reference site directly associated with said base site; and
sensory recognizable indicia identifying said dynamic link to the user.

15. The passive continuity icon of claim 14 wherein the reference site is the base site.

16. The passive continuity icon of claim 14 wherein the sensory recognizable indicia comprises a recognizable logo.

17. The passive continuity icon of claim 14 wherein the sensory recognizable indicia comprises a recognizable color.
